(19) United States
(12) Patent Application Publication
(10) Pub. No.: US 2010/0062232 A1
(43) Pub. Date: Mar. 11, 2010

(54) MULTILAYER FILMS

(75) Inventors: Caroline L. Schauer, Hulmeville, PA (US); Matthew D. Cathell, Philadelphia, PA (US); Holly A. McIlwee, Scranton, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Drexel University, Philadelphia, PA (US)

(21) Appl. No.: 12/296,197

(22) PCT Filed: Dec. 14, 2007
(86) PCT No.: PCT/US07/25563

§ 371 Date: Oct. 6, 2009

Related U.S. Application Data
(60) Provisional application No. 60/875,044, filed on Dec. 15, 2006.

(51) Int. Cl. B32B 7/02; C23F 1/00; C09K 3/00; B32B 5/00; B32B 27/38; B32B 15/02; B32B 9/02; B32B 9/00; B32B 18/00; C08L 5/08; C08L 5/04

(52) U.S. Cl. 428/212; 216/56; 252/182.12; 428/220; 428/413; 428/457; 428/532; 428/688; 428/696; 428/698; 428/702; 428/704; 524/27; 524/28

(57) ABSTRACT

The present invention concerns multilayer films comprising a plurality of layers, at least some of the layers comprise (i) cross-linked chitosan, alginate, chondroitin sulfate, or hyaluronic acid and (ii) particles or void spaces; wherein the layers are 20-260 nm in thickness. Also disclosed are multilayer films comprising at least two of: a layer comprising a first polymer; a layer comprising a second polymer; a layer comprising particles, wherein said particles comprise ceramic material, metallic species, or both; and, a layer comprising a combination of said first polymer and said particles; wherein said multilayer film is capable of displaying structural color. Also provided are methods for making and using the inventive multilayer films and compositions comprising the multilayer films.

### CROSS-REFERENCE TO RELATED APPLICATIONS

The present application claims the benefit of priority to U.S. Provisional Application No. 60/875,044, filed Dec. 15, 2006, which is herein incorporated by reference in its entirety.

### FIELD OF THE INVENTION

The instant invention relates to multilayer films and their use as coloring agents.

### BACKGROUND OF THE INVENTION

Materials that modulate light, such as irises, lenses and reflectors, are among the most intricate nanoscale structures found in nature. Many organisms achieve reflectivity by modulating incident sunlight or bioluminescence, through a process known as structural coloration. Structural color is caused by the interaction of light with nanoscale periodic structures. When light encounters materials with minute structural features (on a comparable size scale to light wavelengths themselves), it is subject to a variety of optical effects including single- and multi-layer thin film interference, diffraction grating effects, photonic crystal effects, liquid crystal effects and scattering. A number of nature's most colorful creatures, including many insects and marine animals, reflect vibrant colors using a mechanism of stacked, thin layers of biomaterials. These stacked structures act as one-dimensional photonic crystals, allowing selective reflection of certain wavelengths of light, while negating other wavelengths by out-of-phase interference. Originally described by Hooke (1665) and Newton (1704), the intense coloration of butterflies, hummingbirds, and arthropods is due to reflective interference by stacked thin layers of film comprised of alternating materials with high and low indices of refraction.

After cellulose, chitin is the second most abundant natural biopolymer on earth and is a non-toxic polymer composed of β(1→4)-linked 2-acetamido-2-deoxy-β-D-glucose (N-acetylglucosamine). The principle derivative of chitin, chitosan, is obtained by N-deacetylation, to a varying extent that is characterized by the degree of deacetylation (DD), and is consequently a copolymer of N-acetylglucosamine and glucosamine, 2-amino-2-deoxy-β-D-glucose. Chitin and its derivatives have found use as substrates for drug and enzyme immobilization, separation membranes, and metal adsorbants for the removal of Hg(II), Cu(II), Cr(III and VI), Ag(I), Fe(III), Mo(VI) and Cd(II) from ground and waste water. A limiting factor in the processing, modification, and application of chitin and chitosan is their low solubility in most organic solvents and solubility of the latter in aqueous dilute acids only. However, a variety of applications, and consequent control of material properties, involve the controlled insolubilization of chitosan and chitosan derivatives via network formation by cross-linking with aldehydes, epoxides, metal ions, and other agents. While effective, both the reactivity and solubility of these agents in aqueous acids or under heterogeneous conditions limit their application and specificity.

Alginate, or alginic acid, is an unbranched binary copolymer of (1→4)-linked β-D-mannuronic acid and α-L-guluronic acid. Alginate readily forms binding interactions with a variety of divalent metal ions, such as calcium. This binding has been used to cross-link bulk alginates for a wide variety of applications, particularly in areas of tissue engineering, medical devices, and wound-healing dressings.

There is an ongoing need in the art for materials that provide excellent color and color control.

### SUMMARY OF THE INVENTION

In some embodiments, the present invention concerns a multilayer film comprising a plurality of layers, at least some of the layers comprise (i) cross-linked chitosan, alginate, chondroitin sulfate, or hyaluronic acid and (ii) particles or void spaces; wherein the layers are 20-260 nm in thickness.

In some embodiments, the void spaces have a largest dimension less than the thickness of the layer in which the void resides. In certain embodiments, the void spaces have a largest dimension less than 50 nm.

In some embodiments, the particles have a largest dimension less than the thickness of the layer in which the particle resides. In certain of these embodiments, the particles have a largest dimension less than 50 nm. Some particles are transition metals. Suitable particles include gold, platinum, and silver. Some particles are substantially spherical. Other particles comprise a wire with a diameter less than the thickness of the layer.

In some embodiments, the film comprises at least one layer with a refractive index of 1.70 to 1.30. In certain embodiments, the film comprises at least two layers and where at least two layers differ in refractive index by at least 0.05.

In another embodiment, the invention relates to a sensor for heavy metal ions comprising a film of claim 1. In some sensors, a film of the invention is adhered to an external surface of a substrate.

In other embodiments, the invention concerns a method of producing a biopolymer film comprising: providing a plurality of layers, at least some of the layers comprising cross-linked chitosan or alginate, the layers comprising a plurality of dispersed particles, the particles having a largest dimension less than the thickness of the layer; and removing the particles from the layer, producing void spaces within the layer.

In some embodiments, the dispersed particles are removed by dissolving the particles in a solvent and separating the solvent from the film. In some embodiments, the particles comprise latex. One suitable latex is carboxylic acid modified latex.

Yet other embodiments of the invention concern a method of producing a composition comprising: forming a multilayer film comprising a plurality of layers, at least some of the layers comprise cross-linked chitosan or alginate and particles or void spaces; wherein the layers are 20-260 nm in thickness, converting the film to a series of pieces, dissolving or dispersing the platelets into a liquid.

In some embodiments, the void spaces are formed by providing a film comprising a plurality of layers having dispersed particles, the particles having a largest dimension less than the thickness of the layer; and removing the particles from the layer, producing void spaces within the layer.

In some embodiments the void spaces are formed before the film is converted to platelets. In other embodiments, the void spaces are formed after the film is converted to platelets.

Also provided are multilayer films comprising at least two of: a layer comprising a first polymer; a layer comprising a second polymer; a layer comprising particles, wherein said particles comprise ceramic material, metallic species, or both; and, a layer comprising a combination of said first polymer and said particles; wherein said multilayer film is capable of displaying structural color.

### BRIEF DESCRIPTION OF THE DRAWINGS

FIG. 1 demonstrates color variation as a function of Ca⁺-Alginate film thickness.

FIG. 2 shows thiol modifications to the chitosan backbone.

FIG. 3 demonstrates cross-linked chitosan (layer 1) and thiol chitosan with 50 nm gold nanoparticles (layer 2) imbedded into the film. The color corresponds to the index of refraction and thickness of the two films.

FIG. 4 shows the results of an investigation of films having alternating layers, where adjacent layers have a different refractive index.

FIG. 5 depicts alternating layers of chitosan-HDACS with PAH-HDACS to six layers produces a green film. The thickness of each layer is approximately 50 nm.

FIG. 6 depicts a schematic of optical sensing platform where the biopolymer films change color when in contact with a solution of heavy metal ions. The proposed system has many films on the dipstick each sensitive to a specific analyte.

FIG. 7 depicts a comparison between (A) a film construction that will provide structural color using a low index of refraction substrate and film, and (B) one that will provide structural color using a high index of refraction substrate and a low index of refraction film.

FIG. 8 illustrates spin coated chitosan-HDACS with 0.33 μm polystyrene carboxylic acid modified, ESTAPOR©Y fluorescent beads. Fluorescent microscope image (at 10×) taken at center of film with scale bar equal to 100 μm.

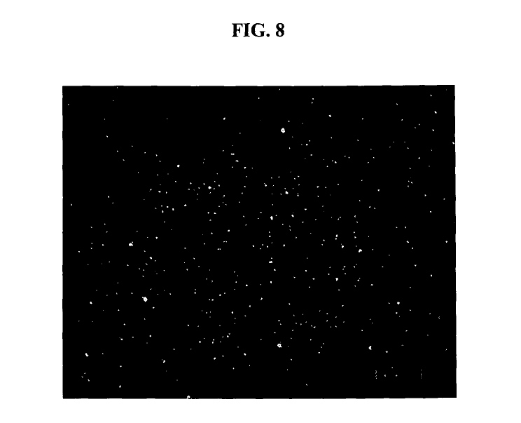

FIG. 9 depicts multiple layers of chitosan-HDACS films. Color is due to the thickness of the film rather than pigmentation.

FIG. 10 depicts the results of a study in which twenty-four alginate films were made from a single solution using identical spin coating conditions to demonstrate the repeatability of the deposition process.

FIG. 11 shows the change in thickness of high MW chitosan-HDACS films as measured with ellipsometry, following five minutes interaction with aqueous 50 ppm solution.

FIG. 12 demonstrates the color change observed between dipping a low MW chitosan-HDACS film in water versus 50 ppm Hg(NO₃)₂ solution.

FIG. 13 depicts how thickness and refractive index measurements can be used to track changes in films, coated at different spin speeds, using cross-linked or non-cross-linked polymer, and after exposure to Pb(II) in a solution of lead(II) acetate.

FIG. 14 provides the results of a study in which changes in thickness and refractive index were measured for films of unmodified and modified cross-linked chitosans after immersion 50 ppm ionic solutions, and compared with previously obtained results from thin films of Ca²⁺-cross-linked alginate.

FIG. 15 depicts reflectance profiles of films made from two formulations of thiol glycolic acid modified chitosan. The different % thiol indicates the different loading of thiol glycolic acid that was covalently attached to the chitosan backbone.

### DETAILED DESCRIPTION OF ILLUSTRATIVE EMBODIMENTS

Multi-layer biopolymer thin films of appropriate thickness are capable of mimicking natural systems. These stacked structures act as one-dimensional photonic crystals, allowing selective reflection of certain wavelengths of light, while negating other wavelengths by out-of-phase interference.

These thin films reflect structural colors that are independent of any intrinsic color, derived from electronic-based light absorption, which the polymer might possess. The colors of structurally colored films shift according to Bragg's law, in which the optical path length is a function of the film thickness and index of refraction. Light reflecting from the air-film surface undergoes constructive and deconstructive interference with light reflected at the underlying polymer-substrate interface, leading to selective wavelength reflection.

Structurally colored thin films have a variety of potential applications, including use as novel reflective and camouflage materials and as a platform for optics-based sensing.

Controlling the stacking of thin biopolymer films, biomimetics can be created for various materials applications, such as antifouling coatings, novel materials for camouflage, paints, fabrics, antireflection surfaces, display technology, photonic devices and bioanalytical sensors.

Polysaccharides are useful in constructing such systems. Useful systems include chitosan, alginate, chondroitin sulfate, and hyaluronic acid.

Chitosan, 1, is a biopolymer which consists of β(1→4)-linked 2-acetamido-2-deoxy-β-D-glucose (N-acetylglucosamine).

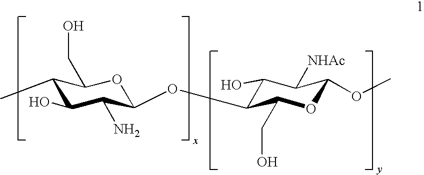

Alginate, 2, is a biopolymer made up of randomly assembled subunits of guluronic acid (G) and mannuronic acid (M). Alginates exist with a variety of ratios and sequencing of these G and M blocks, imparting a range of different polymer properties. (b) Alginate cross-linking readily occurs in the presence of divalent calcium ions. Regions of the alginate chain rich in G subunits, which order into “zigzag” structures with cavities of appropriate size for divalent metals, have heightened specificity for Ca²⁺ because of favorable geometric ordering for coordination.

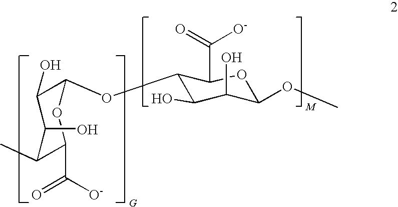

Chondroitin sulfate is composed of a chain of alternating N-acetylgalactosamine and glucuronic acid sugars. Chondroitin chains can have 100 or more sugars. These sugars can be sulfated with a variable number of positions in varying quantities. Chondroitin-4-sulfate, for example is illustrated by formula 3 where: R₁ is H, R₂ is SO₃H; and R₃ is H.

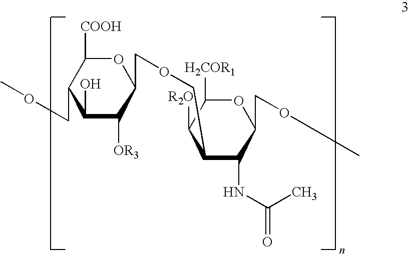

Hyaluronic acid, sometimes referred to as hyaluronan or hyaluronic acid is represented by formula 4 and comprises alternating units of D-glucuronic acid and D-N-acetylglucosamine, linked together via alternating beta-1,4 and beta-1,3 glycosidic bonds. Polymers of hyaluronan can range in size from 102 to 104 kDa in vivo.

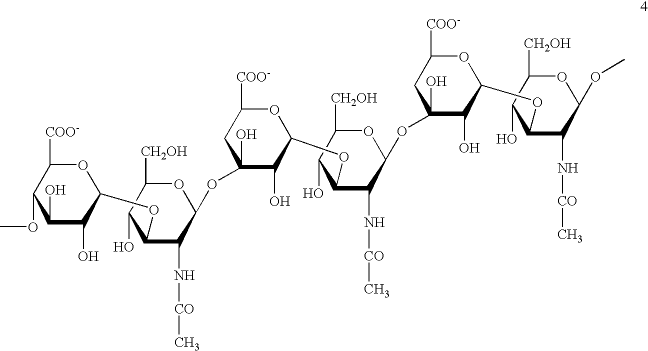

Cross-linking the films can contribute to their stability. In some instances, humidity changes can alter the color of films that are not cross-linked. Suitable cross-linkers include RESIMENE® and compounds of the formulas a, b, and c.

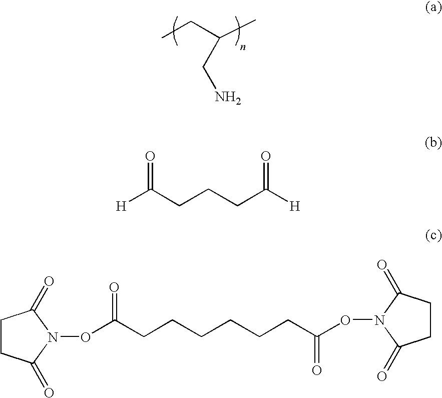

Isocyanates also make good cross-linkers. Due to the reactivity with and insolubility of most commercially available diisocyanates in water, however, the isocyanate can be reacted with a bisulfite to protect or block reactivity and to impart water solubility. One such bisulfite/diisocynate product is 1,6-di(aminocarboxysulfonate) (shown below).

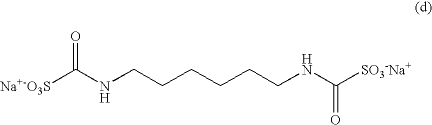

Problems can arise when attempting to use typical Ca²⁺- cross-linking procedures with alginate films. A new method was identified for producing heavily cross-linked alginate thin films, using a procedure that allows for controlled exposure of the polymer to an aerosolized spray of dissolved CaCl₂ in aqueous solution. See, Cathell and Schauer, Biomacromolecules, 2007, 8(1), 33-41. For example, to achieve cross-linking, an aerosol spray of 2.75% calcium chloride was applied to the instant films for periods ranging from 10 s to several minutes. The films were then rinsed for 10 seconds in ultrapure water and dried again under an argon stream on a hotplate.

Changing the quantity of cross-linker in films altered the films' thickness. Increasing the amount of cross-linker will increase the thickness of the layer.

Changing the viscosity of the solution changes the film's thickness. Increasing viscosity increases thickness of the layer.

Changing the amount of polymer in solution changes the film's thickness. Increasing concentration of polymer can increase the thickness of the layer.

Changing the spin speed of the spin coater changes the film's thickness. Increasing the speed decreases the thickness of the layer.

Color of the films can be controlled by altering the thickness of the layers, addition of particles or void spaces in the layers, and use of multiple layers where one or more of the layers optionally have one or more of the aforementioned variations.

One method to alternate the layers is to spin coat contrasting index of refraction polymers. The contrast in index of refraction will determine the number of layers needed to sharpen the reflectance peak. Some natural systems, for example, have a contrasting index of refraction of 1.55-1.00 for the butterfly wing and 1.55-1.30 for the beetle shell.

Another method is to create a biopolymer film with a tunable index of refraction. To this end, ceramic material, metallic species, or both can be incorporated into the film. Spin speed (and therefore thickness) has little effect on the index of refraction of the films. Also, the rate of spin speed correlates well with the resulting thickness of the films, as well as the interference based color. Interestingly, the incorporation of lead ions was able to increase alginate-Ca⁺²′s index of refraction by 0.05. The incorporation of silicon powder changed the index of refraction of chitosan by 0.07. Such differences can be exploited to tune color in the films, as further described herein.

In one embodiment, adding metallic species or ceramic nanoparticles to the biopolymer layers will increase biopolymer's index of refraction and provide new properties for the films. The size of the particles should be such that the largest dimension of the particle is less than the layer thickness in which the particle resides. In some embodiments, the metallic particles are 13-50 nm in size (according to the largest dimension of the particle). Useful metals include transition metals. Specific useful metals include gold, silver, platinum, lead, and palladium. One example of such a film is a chitosan-gold nanoparticle composite thin film. For the metallic species, metal ion solutions may also be used, and can comprise, among others, lead acetate, zinc chloride, copper (II) sulfide pentahydrate, and chromium (III) chloride. Metallic powders may also be used. Ceramic particle sizes may range from about 2 to about 50 μm, and can comprise oxides (e.g., alumina, zirconia), non-oxides (e.g., carbides, borides, nitrides, silicides), or composites (combinations of oxides and non-oxides). Exemplary ceramics include barium titanate, bismuth oxy chloride, bismuth strontium calcium copper oxide, boron carbide, boron nitride, ferrite, lead zirconate titanate, magnesium diboride, mica, micaboron nitride, micronized diamonds, titanium oxide, titanium dioxide, sialons, silicon carbide, silicon nitride, steatite, yttrium barium copper oxide, zinc oxide, and zirconium dioxide. The ceramic particles may be roughly or substantially spherical, irregularly shaped, or flakes. Without intending to be bound by a particular theory of operation, it is believed that the suspension of particles of various refractive indices in a polymer matrix functions in the manner of a photonic crystal.

Metal nanoparticles are of interest because of their unique electronic, optical, and catalytic properties. The integration of metal nanoparticles into thin films is particularly important for various applications, for example, vapor sensing, high reflectance distributed Bragg reflectors and in the preparation of optoelectronic nanodevices. Films of close-packed metal nanoparticles can be achieved via self-assembly of metal nanoparticles from organic media onto solid supports. However, the formation of dense films of metal nanoparticles from aqueous nanoparticle dispersions is often difficult to obtain. For example, previous reports demonstrate that the surface coverage of gold nanoparticles adsorbed from aqueous solution onto substrates is less than 30%.

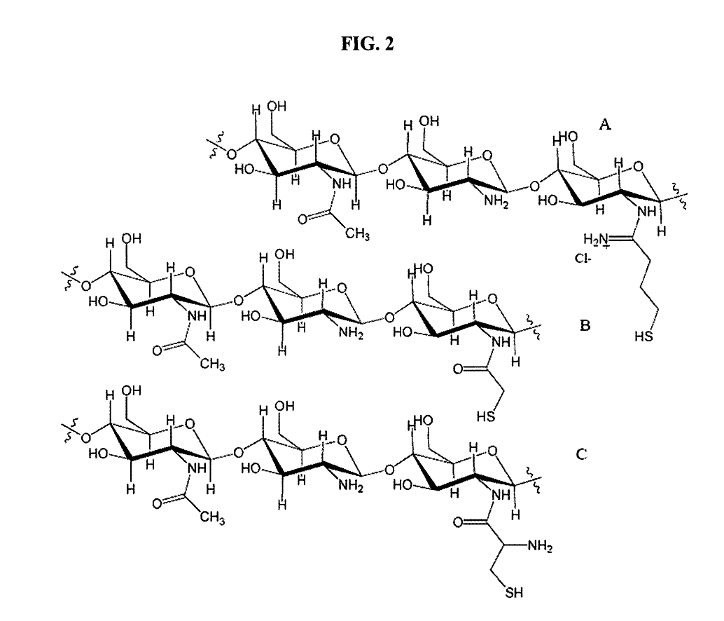

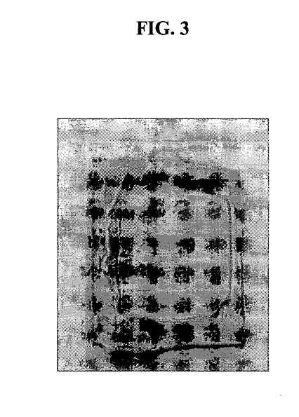

One approach to increase the nanoparticle loading on surfaces is using additional linker molecules to bind nanoparticles to the surface. Modification of chitosan by attaching thiol groups (FIG. 2) is proposed to increase the gold nanoparticle loading. The metal nanoparticle will bind to the chemically modified group on chitosan to stabilize the metal-chitosan interaction and aid in the deposition (FIG. 3).

In another approach, air pockets can be incorporated into the polysaccharide (chitosan, for example) layer to lower the refractive index of that layer. One method of creating films with void spaces is to incorporate a polymer in the film that forms a series of domains. The polymer can then be removed by contacting the film with a solvent that dissolves the polymer but does not appreciably damage the film.

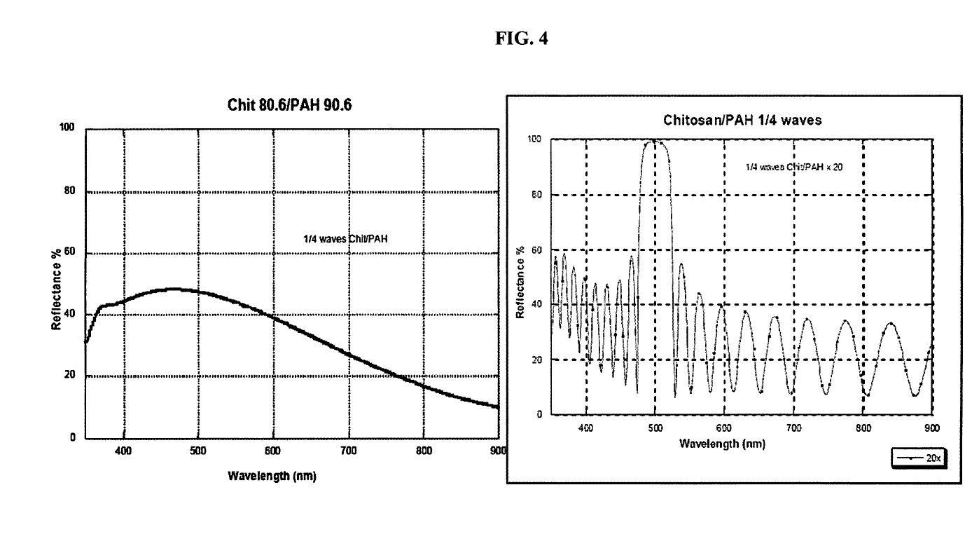

In some embodiments, methods for making void spaces include starting with silica or polystyrene nanospheres and the desired polymer which fills the vacant space between the nanospheres, create the three dimensional structure (FIG. 4), and then remove the spheres using solvent or thermal decomposition. This approach can be used, for example, in the creation of multilayers with every other layer having air pockets as the nanoparticles can be removed after the entire material has finished stacking.

In one preferred embodiment, latex polymer can be incorporated into chitosan film and removed by THF, a solvent that the film is not soluble in. The film can optionally be washed with a solvent to ensure suitable removal of the latex polymer residue.

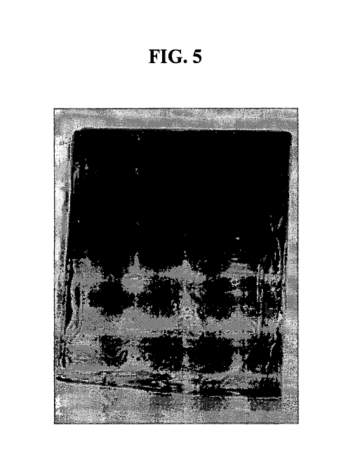

Layering the chitosan films with materials possessing different refractive indices sharpens the reflected peak as seen in FIG. 4. Using Film Wizard modeling program, alternating the chitosan films, index of refraction 1.56, with a lower index of refraction material, poly(allyl amine) (a) at 1.38, sharpens the reflectance maximum with increasing layers (FIG. 5). However, this contrast in index of refraction is smaller than what is observed in nature and twenty layers of each polymer film are needed to sharpen the reflectance peak. One way to increase the contrast is to use two organic photo-cross-linkable polymers with high (1.70-1.60) and low (1.41-1.38) indexes of refraction.

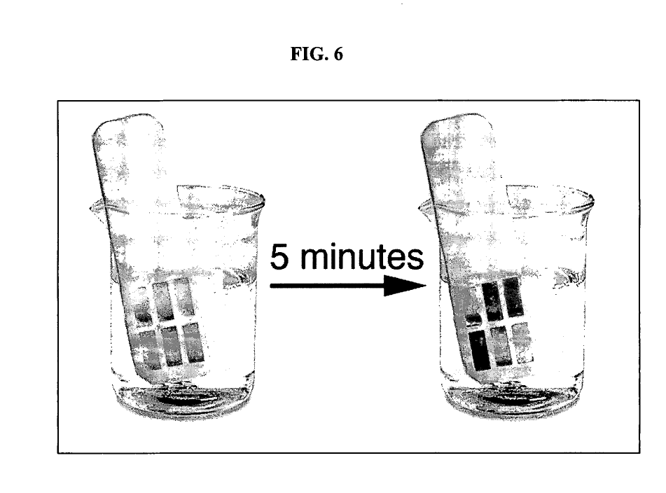

The films of the present invention can be used for a variety of applications. An ideal metal ion sensor for the residential analysis of water would be an inexpensive, rapid, color-based, dipstick test for heavy metal salts in waste and drinking water. The dipstick would have different panels of sensitive films that change colors in response to the presence of heavy metal ions in water (FIG. 6). The dipstick field test would compliment current laboratory-based techniques as a means of on-site identification of water sources that would require more rigorous laboratory testing. Dipstick approach identifies undrinkable water on site in the matter of minutes, is created from biopolymer films and easy to use. Because chitosan has metal ion absorbance capabilities and corresponding color changes, thin single films of polysaccharides such as chitosan can be used to distinguish metal ions using a change in optical properties and thickness. One useful film is a thin film of cross-linked chitosan-RESIMENE®, chitosan-HDACS, alginate-Ca²⁺, modified chitosan or poly(allyl amine) (PAH)-HDACS. Example 8, infra, and FIG. 6 provide exemplary embodiments of optical dipsticks in accordance with the present invention.

Another end use would be to produce suspension of platelets of thin cross-linked or non-cross-linked films, such as chitosan films, for use in providing coatings of colored films. Such dispersions can be made in an aqueous or organic liquid. The dispersions can be applied to a substrate and at least a portion of the liquid allowed to evaporate to produce a coated substrate. End uses could involve coatings, for example, on glass, acrylic, or human nails (keratin), in the form of paints and cosmetics such as nail polish. To this end and others, there are herein provided multilayer films comprising at least two of: a layer comprising a first polymer; a layer comprising a second polymer; a layer comprising particles, wherein said particles comprise ceramic material, metallic species, or both; and, a layer comprising a combination of said first polymer and said particles; wherein said multilayer film is capable of displaying structural color. It is intended by the use of the terms “first polymer” and “second polymer” to indicate that layers that respectively comprise different polymers can be used, not to indicate the sequence in which the respective polymer layers appear in the instant multilayer films.

The instant films may comprise any polymer as previously described herein. For example, biological polysaccharides and other biopolymers, whether synthetic or naturally-derived, may be used. Other suitable polymers may also be used, as will be readily appreciated by those skilled in the art.

In the instant multilayer films, the layer comprising a first polymer may also include void spaces. Void spaces may have the characteristics as previously disclosed and may be formed in accordance with the preceding disclosure. The void spaces preferably have a largest dimension less than the thickness of the layer in which the void spaces reside.

The layers of the instant multilayer films be spin coated onto surfaces or painted on with a brush, such as an acrylic brush. The thickness of such layers may be from about 20-260 nm to about 0.9-1.2 μm. The identity and physical characteristics of the ceramic material and metallic species may be as described previously in the present application.

Controlled stacking of the disclosed multilayer films can be utilized for various materials applications, such as, for example, antifouling coatings, coatings for nail polish, camouflage, paints, fabrics, antireflective surfaces, display technologies, photonic devices, and biolanalytical sensors. Biopolymers such as chitosan, alginate, hyaluronic acid, and chondroitin sulfate have refractive indices of n=1.51-1.55. At present, structural color technology is being applied to printer ink and color display applications. Po-Chuan, et al. describe the use of ink jet printer ink that provides a film of red, green, and blue organic color resists on to the surface of glass. See Pan, Po-Chuan, et al., Organic color films prepared by inkjet printing method and its properties. IEICE Transactions on Electronics, v E89-C, n 12, Dec. 2006, 1727-31. Alethia G. de Leon, et al. use polytetrafluoroethylene to produce structures which feature a strong, angle-dependent absorption of polarized visible light, which allows for optical switching between red and blue and between green and yellow for use in full-color displays. See Alethia G. de Leon, et al., Method for fabricating pixilated, multicolor polarizing films. Applied Optics. 10 Sep. 2000 y Vol. 39, No. 26.

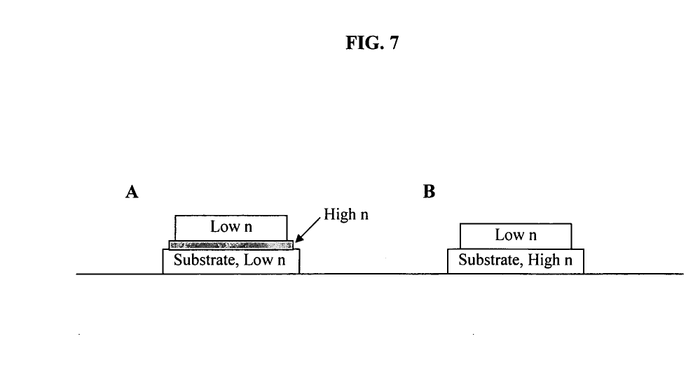

In some embodiments, the present multilayer films can comprise a material having an index of refraction of at least 0.05, but preferably 0.2, higher or lower than that of the substrate material in order to create structural color on such substrate (e.g., glass, acrylic, or keratin). Glass, acrylic, and keratin have refractive indices of 1.5, 1.46-1.55, and 1.54, respectively. As shown in FIG. 7A, in order to see structural color in polymer thin films when a substrate is used, the film system may comprise polymer film positioned on a substrate with a low refractive index (such as glass, acrylic, or keratin), with an intermediate layer of a high refractive index material (such as a metallic species or a ceramic material). This is to be compared with the condition depicted in FIG. 7B, which includes a low refractive index polymer positioned on a high refractive index substrate (such as a silicon wafer, which would have a refractive index of n=3.62), and which displays structural color.

Adding metallic species or ceramic materials to the polymer layers can increase the polymer layer's index of refraction and provide new properties for the films, including enabling structural color when the polymer has a refractive index that is similar to the substrate onto which the film is applied. However, in situations where raising the refractive index of a polymer by adding particles is not desirable, in order to create a colorful layer of polymer with a refractive index on a substrate with a similar refractive index, an intermediate layer of metallic species or ceramic material may be included. Metal ion sputtercoating is one way to achieve this layering effect. For example, sputtercoating a layer of platinum or palladium-platinum mixture that is thinner than a subsequent layer of polymer is one way to achieve this effect. The refractive index of platinum is reported to be n=2.33. The instant multilayer films can comprise a layer comprising a first polymer, a layer comprising a metallic species, and a second layer comprising a first polymer, wherein said layer comprising a metallic species or a ceramic material or both is interposed between said layer comprising a first polymer and said second layer comprising a first polymer.

In other embodiments, other polymers may be used to create the dielectric contrast needed for the instant polymer thin films to exhibit structural color vis-à-vis another polymer layer having a different index of refraction, without the aid of a high refractive index substrate or intermediate layer. For example, poly(2,2,3,3,4,4,4-heptafluoromethacrylate-co-glycidyl methacrylate) has a reported refractive index of n=1.3. Poly(pentabromo-phenylmethacrylate-co-glycidyl-methacrylate) has a reported refractive index of n=1.7. Polymerized titanium methacrylate triisopropoxide has a measured refractive index of n=1.8. Layering experiments with materials such as these and others that will be readily appreciated by those skilled in the art can create the dielectric contrast need for the instant polymer thin films to exhibit structural color without the aid of a high refractive index substrate or intermediate layer. For example, structural color may be created by applying a layer of polymerized titanium methacrylate triisopropoxide to a keratin substrate, followed by a layer of chitosan polymer; in this embodiment, suspended metallic or ceramic species or a layer of metallic or ceramic species need not be present, since the refractive mismatch between the substrate, first polymer layer, and second polymer layer is sufficient to provide structural color. Therefore, in some embodiments, the instant multilayer films may comprise a layer comprising a first polymer and a layer comprising a second polymer, wherein said layer comprising a first polymer is adjacent to said layer comprising a second polymer without intervening layers, and wherein the refractive index of said second polymer is higher than the refractive index of said first polymer.

In previous biopolymer thin film studies, films were created by spin coating a droplet of polymer onto a silicon wafer. For the end use of nail polish, optical color films are prepared by painting the polymer material onto a substrate (which may be, inter alia, plastic, glass, acrylic, keratin, or black and white test sheets) with an acrylic brush. For the purpose of identifying structural color on glass, acrylic, human skin, or keratin, the same “painting” technique is utilized for these or other similar substrates. When painting samples, approximately 0.25 mL of solution is picked up by the brush when it is dipped into the vessel in which the solution is contained, and is painted onto the chip, thereby covering the majority of the chip's surface. The films may be dried, e.g., with an N₂ stream, thermally dried on a hot plate, or air dried.

When painted onto a surface (for example, using a bristle brush), each of the resulting layers may have a thickness of approximately 0.9-1.2 μm, which is thicker than would be provided through use of spin coating techniques. The thickness of the layers can also be altered by modifying the concentration of the polymer or addition of a drying agent so that excess solution can be dried off, thereby leaving a thinner coating of polymer. Varying amounts of diluent can be added to an existing polymer solution, e.g., varying amounts of 1% acetic acid can be added to existing chitosan solution. A thinner polymer solution can provide a smoother color distribution as a result of fewer thickness changes across the surface of the layer.

For the purpose of measuring a film's refractive index and thickness, a film sample may be coated onto a silicon chip. Silicon chips are prepared for coating by first cleaning ˜4 cm pieces using a modified RCA protocol. See L. Shriver-Lake in: T. Cass, F.S. Ligler (Eds.), Immobilized Biomolecules in Analysis, Oxford Univ. Press, Oxford, 1999, p. 1 (see Example 1, infra). Film thickness and refractive index may be measured using a variable-angle ellipsometer, which measures the change in the polarized state of light reflected from or transmitted through the surface of a sample. A film's reflected color is measured using a reflectance spectrometer, which measures the percentage of light reflected at given wavelengths, which correlates to the color of the sample.

In some samples, the polymer film is lifted from the surface of the substrate and its structural color is observed in front of multiple backgrounds. A film that appears blue on a silicon wafer will appear transparent when held in the air and against a white background. However, that same film will appear multicolored when it is placed in front of a black background. Thus, black and white color test sheets may be used to determine if structural color can be observed on a black or white substrate, respectively. In one preparation, for example, films containing polymers such as chitosan or chitosan-containing particles or ions are adhered to the external surface of a substrate, for example, of glass, acrylic, keratin, black and white color test sheets, or dry nail enamel strips.

The polymers for use in the present multilayer films can be cross-linked or non-cross-linked. Cross-linking the polymers can contribute to their stability. In some instances, humidity changes can alter the color of films that are not well cross-linked. Suitable cross-linkers include RESIMENE®, glutaraldehyde, genpin, epichlorohydrin, bifunctional cross-linkers, homo-functional cross-linkers, and isocyanates, among others. Due to reactivity with and insolubility of most commercially-available diisocyanates in water, however, the isocyanate can be reacted with a bilsulfite to protect or block reactivity and to impart water insolubility. One such bisulfite/diisocynate product is 1,6-di(aminocarboxysulfonate). In one embodiment, to produce the cross-linked chitosan-1,6-di(aminocarboxysulfonate) (“HDACS”) films, 50 mg of HDACS was added to a chitosan solution comprising 400 mg chitosan in 30 mL 1% acetic acid. The substrates were placed on an 80° C. hot plate for 30 min for drying, and were subsequently placed into a 120° C. oven for 2 hours to cross-link and cure.

Additional techniques for cross-linking chitosan or other polymers of the present films include the use of photocross-linkable polymer, such as photocross-linkable chitosan, or the use of thermal gelling polymer. For example, one may use a photocross-linkable chitosan to which both azide and lactose moieties are introduced through condensation reactions (Az-CH-LA). See Ono K, et al., Journal of Biomedical Materials Research. Vol. 49 (2), pp 289-295. Another option for cross-linking chitosan or other polymers of the present films includes the addition of glycerophosphate disodium salt (GP). Previous studies have involved the use of thermally sensitive chitosan-GP solutions for injectable hydrogels to promote anticoagulation and immunostimulatory activities. See Ganji F, et al., J. Sol-Gel Techn 2007. Vol. 42, pp 47-53. In that study, gelation rates were studied at 37° C.; for purposes of gelling on a nail bed, GP concentration and polymer (e.g., chitosan) solution pH can be modified to provide the appropriate gelation rate for the temperature at the surface of a human nail that is exposed to ambient air, i.e., about 33° C.

In accordance with the present invention, the arrangement of the disclosed polymer films may be rearranged in order to alter the structural color properties thereof. Photonic crystals are structures comprising materials having dielectric contrast, arranged with periodicity comparable to the size of a wavelength of light. Crystal structure controls the propagation of light through the material. Some wavelengths of light may not be able to propagate through a photonic crystal, and make up its photonic band gap. Photonic crystals can be created with composite materials (made of two or more materials with dielectric contrast). Such materials exhibit structural color, caused mainly by interference on a surface of the periodically ordered species. Periodic species may comprise nanoparticles and/or void spaces.

The invention is further illustrated by the following examples which are not intended as limiting.

### EXAMPLE 1

### Chitosan Films

### Materials

Chitosan of high molecular weight (240 kDa) and greater than 70% deacetylation was supplied by Protan (Raymond, Wash.).

### Chitosan Preparation

As previously described, commercially purchased chitosan was decolorized, further deacetylated to improve solubility, and purified to remove extraneous material, such as pieces of crab shell, achieving approximately 80% deacetylation. The degree of deacetylation was determined using two independent methods: H¹ NMR and IR. Integration of three key H1 NMR (50 8C, 2% CD₃COOD in D₂O with trace sodium phosphate) peaks, taken on a 400 MHz Brucker NMR, indicated that the degree of deacetylation was 80.1%. The IR spectrum of a chitosan KBr pellet taken on a Nicolet Impact 400D (Madison, Wis.) had a large amide I peak at 1653 cm⁻¹, which was indicative of an approximately 78% deacetylated chitosan according to Mima et al, J. Appl. Polymer Sci. 28, 1909 (1983). The UV-visible spectra taken on a Hewlett-Packard 8453 spectrophotometer (Wilmington, Del.) of the bulk chitosan solutions revealed no peaks above 300 nm.

### Preparation of Films

Silicon chips (˜4 cm) were cleaned twice using a modified RCA protocol. See, L. Shriver-Lake, in: T. Cass, F. S. Ligler (Eds.), Immobilized Biomolecules in Analysis, Oxford University Press, Oxford, 1999, p. 1. First, the chips were immersed in a solution of NH₄OH:H₂O₂:H₂O (1:1:5) at 80° C. for 5 min. The chips were then rinsed repeatedly with water and immersed in a solution of HCl:H₂O₂:H₂O (1:1:5) at 80° C. for 5 min. After additional rinsing, the chips were dried under a N₂ stream. For spin coating, approximately 0.4 ml of the solution was placed on the chip covering the majority of the surface. The chips were spun at 2000 rev/min for 30 s using a spin-coater from Specialty Coating Systems, Inc. (Indianapolis, Ind.).

### EXAMPLE 2

### Alginate Films

### Materials

Alginic acid sodium salt from brown algae, ethylenediaminetetraacetic acid (EDTA), and all metallic salts were purchased from Sigma-Aldrich. The alginate salt had an approximate mannuronic/guluronic ratio of 1.56, a degree of polymerization range of 400-600, and a molecular weight (Mw) range of 80,000-120,000. All chemicals were used as received. Room-temperature ultrapure water (Millipore QPAK system) was used to make all solutions and for silicon wafer cleaning and film rinsing procedures.

### Alginate Thin Film Deposition and Cross-Linking

Quantities of sodium alginate, ranging from 0.2 to 0.4 g, were dissolved in 30 mL aliquots of ultrapure water. The solutions were filtered in bulk through a coarse fritted glass filter funnel and degassed in a sonicator for 5 min. Further filtration was performed using 0.8 fm Nalgene syringe prefilters (VWR). Small amounts of solutions (˜0.3 mL) were dispensed onto fragments of polished silicon wafers (of typical area 6.25 cm²). The silicon wafers had been previously cleaned using a modified RCA protocol. Thin films were produced by spin coating the wafers in a WS-400B-GNPP/LITE/AS spin processor (Laurell Technologies, North Wales, Pa.) operating at speeds between 1000 and 4000 rpm for 30-60 s. After coating, the films were dried under a stream of argon while on a hot plate at the lowest temperature setting. To achieve cross-linking, an aerosol spray of 2.75% calcium chloride solution was applied to the films for periods ranging from 10 s to several minutes. The films were then rinsed for 10 s in ultrapure water and dried again under an argon stream on a hot plate.

### EDTA Treatment of Alginate Films

To establish Ca²⁺ ions as the thin films' cross-linking agent, cross-linked samples were exposed to EDTA, a calcium chelator. Solutions of EDTA at concentrations of 0.001, 0.01, and 0.1 M were made using ultrapure water and neutralized with 5 M NaOH. Cross-linked alginate films on small fragments of silicon wafer were placed in shallow sample dishes with 20 mL of the EDTA solutions. Film samples immersed in ultrapure water for the same period of time served as a control. After 5 min, the liquids were decanted from the sample dishes and the samples were dried. Thickness, refractive index, and reflectance measurements were made before and after EDTA treatment for comparison.

### EXAMPLE 3

### Ca²⁺-Alginate Films of Different Thicknesses

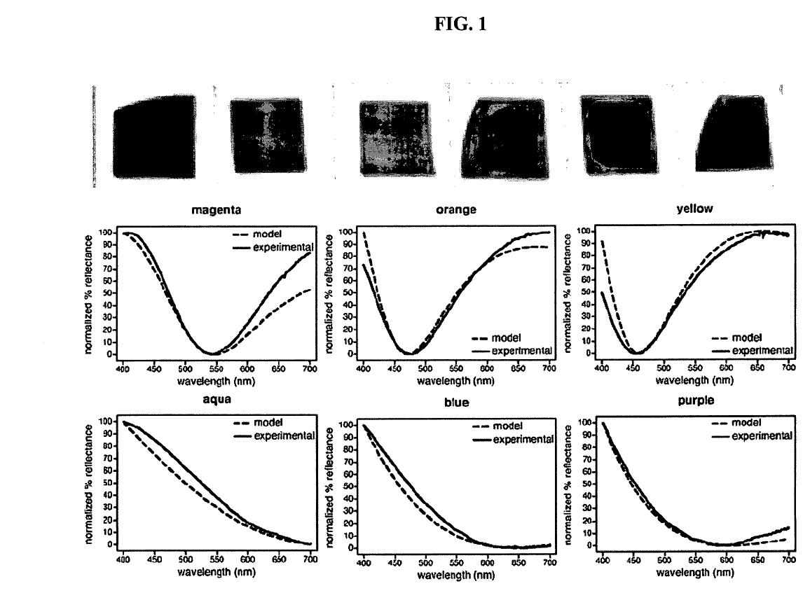

Ca²⁺-Alginate films were produced by spin coating as described herein. The thicknesses of these Ca²⁺-Alginate films (in nm) and their associated color are 266.5 (magenta), 226.2 (orange), 219.9 (yellow), 122.4 (aqua), 102.8 (blue), and 95.8 (purple). The mean refractive index is 1.521. In FIG. 1, normalized reflectance spectra in the visible wavelength regime (solid curves, measured from reflectance spectrometry) are shown for each film, along with the model predictions for the same wavelength range (dashed curves, calculated using ellipsometer-determined thickness and index values).

These results also provide insight as to the effects of deposition spin speed on structural color for alginate-Ca²⁺ cross-linked thin films. Control over the structural coloration of alginate films is also highly tunable. Films of various thicknesses were produced with a wide variety of reflected colors. Because of the short duration of the Ca²⁺cross-linking cycle, it is possible to rapidly coat multiple layers of cross-linked alginate on the substrate to achieve different reflectance effects. However, it is also possible to adjust reflectance properties in a single coating by varying polymer solution viscosity (through concentration, molecular weight, pH, temperature, etc., as discussed herein) and processing variables (spin coating velocity, acceleration, and duration).

The thin films shown in FIG. 1 are all one-layer samples produced in a single application cycle, and illustrate the versatile control over film coloration. Experimental reflectance measured with the fiber optic reflectance spectrometer (solid curves) and model reflectance calculated with thickness and refractive index parameters determined by ellipsometry (dashed curves). The experimental and modeled spectra have been normalized (with the smallest and largest values from each data set scaled to 0 and 100% reflectance, respectively). The modeling software used thickness and index dispersion data to predict, with good accuracy, the wavelength position of minima and maxima along the reflectance curve. Deviations in the normalized reflectance intensity along the vertical axis may be rooted in approximations and assumptions used in the modeling calculations, but may also be an indication of slight color heterogeneity at different points in the films' surfaces. This effect becomes more pronounced as film thickness increases and surface topology becomes less planar, producing slight color variations that are visible to the unaided eye (particularly in the magenta and orange films). Because the samples were measured using two different instruments (with similar but slightly different sample spot sizes), it was impossible to ensure that a film was measured at precisely the same spot on both instruments. Nonetheless, the modeled data generated by the ellipsometer were a good match for the reflectance observed experimentally, providing confirmation that the physical and optical parameters measured by the ellipsometer are experimentally sound.

### EXAMPLE 4

### Chitosan-HDACS Film Preparation

To create the cross-linked chitosan-1,6-di(aminocarboxysulfonate) [HDACS] films, 45 mg of HDACS was added to the chitosan solution, 225 mg of chitosan/30 mL of 2.5% acetic acid. To create the cross-linked PAH-HDACS films, 60 mg of HDACS was added to 2.5 mL of PAH (50% solution in water) in 27.5 mL of water.

For spin coating, ˜0.4 mL of the above solution was placed on the chip covering the majority of the surface. The chips were spun at 2000 rpm for 30 s using a spin-coater from Specialty Coating Systems, Inc. (Indianapolis, Ind.). The substrates were placed on an 80° C. hot plate for 30 min to dry, then into a 120° C. oven for 2 h to cross-link and cure.

### EXAMPLE 5

### Stacked Chitosan Films

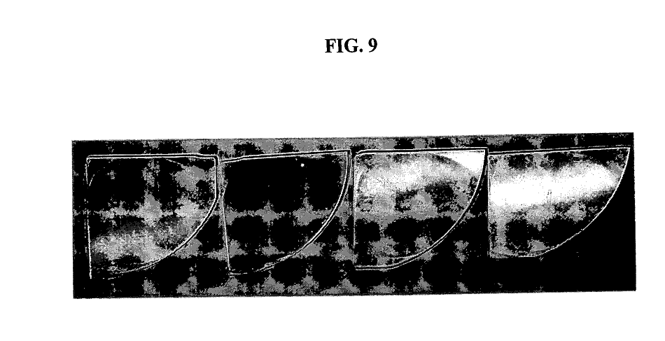

In investigating the deposition properties of chitosan, cross-linked uniform films were created through spin coating. The film's thickness can range from 50-260 nm depending on the cross-linker used and the concentration of the solution, which relates to the viscosity. Cross-linked chitosan can be spin coated into a single layer, whose index of refraction was determined to be 1.56. Depending on the thickness of the cross-linked chitosan layer and the substrate it was spun on, interference colored films were observed. Studies demonstrate thin films of cross-linked chitosan spun onto polished silicon wafers creating vibrant colors, where the color is determined by the thickness and index of refraction, not pigmentation. The film colors, grey, purple, blue to yellow, correspond to the total thickness, 50 nm, 100 nm 150 nm to 200 nm and number of 50 nm layers, one, two, three to four (FIG. 9). These films' reflectance maximum did not sharpen because all layers have the same index of refraction. However, the films indicate that multiple layers of chitosan can be stacked. Once cross-linked, studies have found that these films are stable to acids, bases, alcohols and chloroform.

### EXAMPLE 6

### Film Characterization

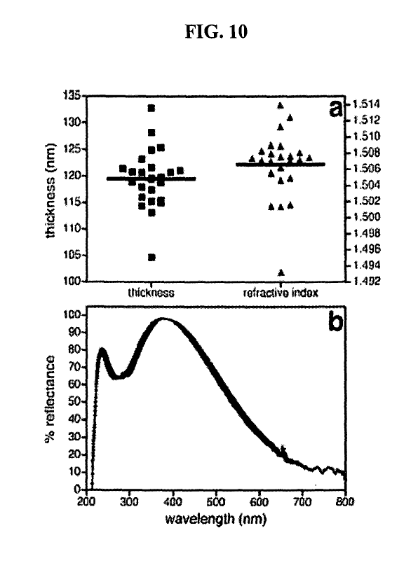

To demonstrate the repeatability of the spin coating deposition process, 24 films were spun from a single solution using identical deposition parameters (FIG. 10). Each film was exposed to aerosolized CaCl₂ solution for ten seconds before being rinsed and dried. This aerosol application technique allows the calcium to be evenly applied over the film's surface without the problems associated with directly dipping the films into solution. The evenness of cross-linking is evidenced by the films' retained smoothness and virtually constant radial coloration from center to edge. Ellipsometry and reflectance data were gathered for each sample. Film thicknesses and indices of refraction were determined using an M-2000U variable angle spectroscopic ellipsometer (J.A. Woollam Co., Lincoln, Nebr.). An ellipsometer measures changes in phase and polarized state of an electric field upon reflection, in order to calculate information about a sample's physical and optical properties—in this case, the thickness and refractive index of a biopolymer thin film. The data provided by the instrument are the Stokes parameters Ψ and Δ, which are related to the Fresnel reflection coefficients of light parallel and perpendicular to the plane of incidence, Rₚ and Rₛ. The ratio of the Fresnel coefficients, called the reflection coefficient ratio, is given by the expression:

$$\frac{{R}_{p}}{{R}_{s}} = tan ( Ψ ) {e}^{iΔ}$$

Data from the biopolymer thin films were gathered over a wavelength range of 200 to 1000 nm, at a typical reflectance angle of 60°. The refractive indices of the films were calculated using the Cauchy parameterization function, which yields refractive index dispersion as a function of wavelength λ (in microns). The thin films were analyzed using the first three Cauchy fit parameters A, B and C:

$$n ( λ ) = A + \frac{B}{{λ}^{2}} + \frac{C}{{λ}^{4}}$$

All refractive index values are reported at a wavelength of 589.3 nm (the mean sodium D-line). Fitting was performed in the WVASE32 software (J.A. Woollam Co.) using a Levenberg-Marquardt regression algorithm to minimize mean standard error (MSE) between the experimentally obtained Ψ and Δ terms and a model curve. This fitting was accomplished through adjustment of the Cauchy parameters and thickness in a series of error minimization calculations. Convergence was reached when the algorithm was unable to minimize the MSE through further iterations, yielding the reported thickness and refractive index measurements. Using thickness and refractive index dispersion data gathered from the ellipsometer, model reflectance data was generated in WVASE32 to predict wavelength reflection. The modeling parameters chosen included an unpolarized broadband light source back-reflected at an angle normal to the film surface, with the assumption that the optically dense silicon substrate would require no backside correction. The generated model reflectance profiles were compared with experimental reflectance data measured with the reflectance spectrometer. Since the film's color changes with the angle of measurement (45° vs. 90°), only the light back reflected at 180° was measured. The reflectance spectrometer used was a USB2000 Miniature fiber optic spectrometer with DH-2000 deuterium tungsten halogen light sources (Ocean Optics, Dunedin, Fla.).

As shown in FIG. 10a, the films' thicknesses were centered on a value of 119.5±1.1 nm. The Cauchy-calculated refractive index, n, at a light wavelength of 589.3 nm was 1.507±0.0008. Lateral spread of data points in each column is used to emphasize clustering of measurements about the mean thickness and refractive index.

In FIG. 10b, the reflectance of the 24 films is plotted as an averaged curve (black) with standard error. The mean reflectance maximum was measured at 379.3, with little standard error among the samples (±2.9 nm).

### EXAMPLE 7

### Demonstrating a Tunable Index of Refraction

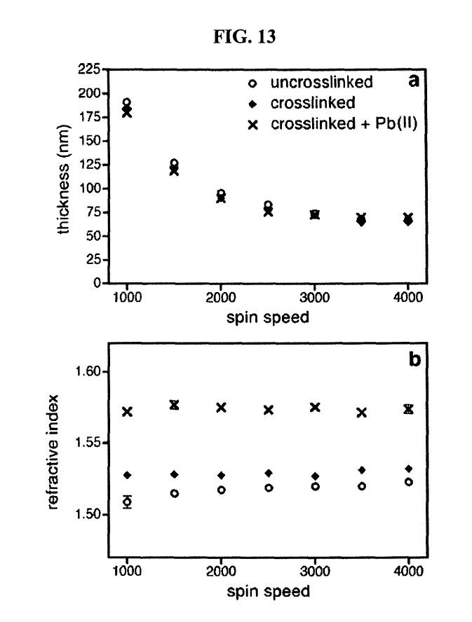

FIG. 13 illustrates how thickness and refractive index measurements can be used to track changes in thin films, coated at different spin speeds, in their initial non-cross-linked states, after cross-linking with Ca²⁺ and finally after exposure to 50 ppm Pb(II) in lead(II) acetate solution. FIG. 13a shows that thickness measurements can be directly correlated to the spinning velocity in the coating process, and follow an exponential decay curve as velocity increases. Because of the relatively small thickness change associated with cross-linking and Pb(II) exposure, there is overlap in the data points. In FIG. 13b, it may be observed that measurements of refractive index remain essentially unperturbed by changes thin film processing speed, and are not tied to initial film thicknesses. There is clearly discernable different between measurements of films in various states: uncross-linked (mean n=1.518±0.002), cross-linked (mean n=1.529±0.001), and Pb(II)-exposed (mean n=1.575±0.001).

### EXAMPLE 8

### Dipsick Sensor

Initial work with colored thin films of cross-linked chitosan-Resimene© and poly(allyl amine) (PAH), glutaraldehyde demonstrated that these films change their thickness and color in response to all metal ion solutions tested, therefore creating a generic sensor platform. The response of the generic sensing films of cross-linked chitosan and PAH were found not to be dose-dependent, with all metal ion solutions tested generating similar thickness and color responses. However by altering the cross-linker, the films tuned their specificity for metal ion solutions. Chitosan-hexamethylene 1,6-di(aminocarboxysulfonate) (HDACS) films increased in thickness and red shifted their reflectance spectra in the presence of CrO₃. PAH-HDACS films increased in thickness and red shifted their reflectance spectra in the presence of Cu(I and II) salts.

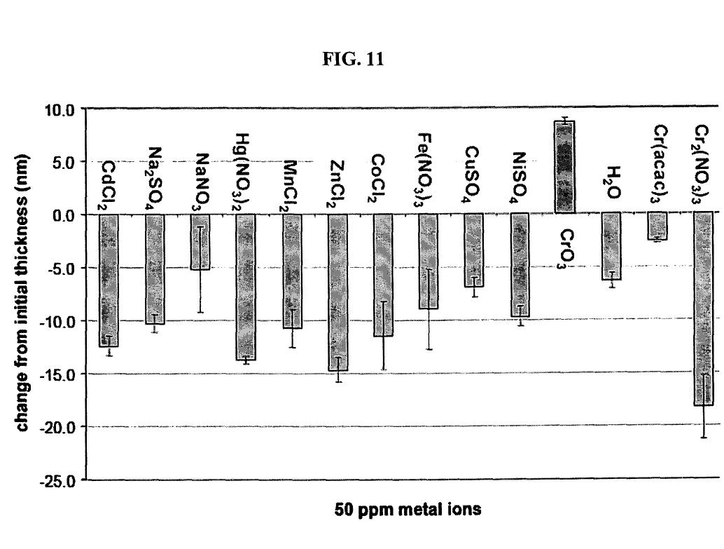

As seen in FIG. 11, the chitosan-HDACS changes color, red shifts, upon dipping into a 50 ppm CrO₃ solution and blue shifts for all other metal ion solutions. But, because these single layers produce a broad reflectance maximum peak corresponding to the film's color, a large quantity of analyte is required to produce a marked color change. For biopolymer/organic thin films to be incorporated into a designed photochromic device, the materials must experience a substantial shift in the index of refraction or thickness to induce a color change. Using nature's structural color as a model, alternating layers of high and low index of refraction sharpens the reflectance peak and should increase the sensitivity of the photochromic sensing platform.

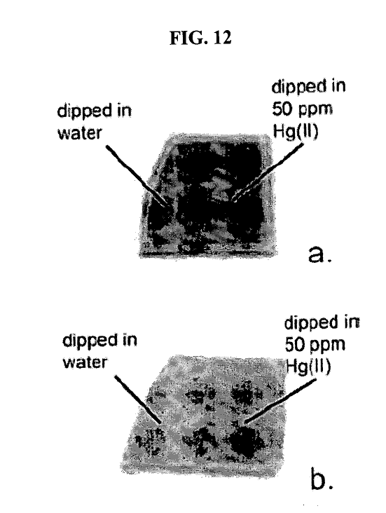

FIG. 12 (top) demonstrates the color change observed between dipping a low MW chitosan-HDACS film in water versus 50 ppm Hg(NO₃)₂ solution. The bottom set of films is of low MW chitosan-HDACS with gold nanoparticles imbedded into the films. The left one was dipped into water and the right one 50 ppm Hg(NO₃)₂ solution. The ability to see the change in color visually without the need for additional equipment makes the development of an optical dipstick a valuable sensing tool.

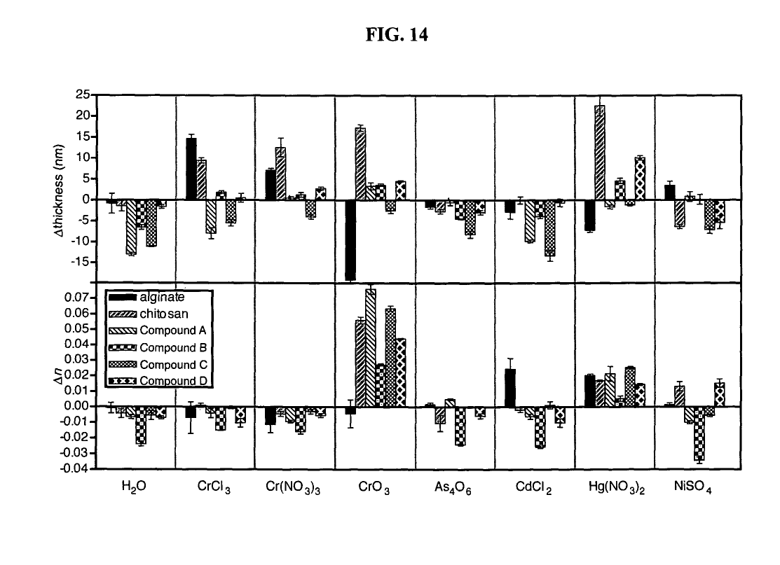

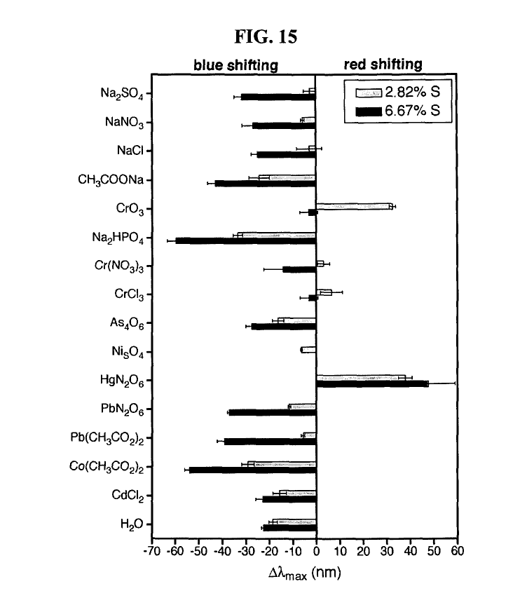

FIG. 14 demonstrates that by changing the polymer layer changes the sensitivity to the metal ion solution. Each bar is representative of three interference colored films, whose thickness, reflected color and index of refraction were measured before and after dipping into an aqueous metal ion solution. Especially indicated by FIG. 15 is that the specificity towards mercury improves by increasing the amount of thiol groups.

When ranges are used herein for physical properties, such as molecular weight, or chemical properties, such as chemical formulae, all combinations and subcombinations of ranges and specific embodiments therein are intended to be included.

The disclosures of each patent, patent application and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A multilayer film comprising a plurality of layers, wherein at least some of the layers comprise (i) cross-linked chitosan, alginate, chondroitin sulfate, or hyaluronic acid and (ii) particles or void spaces; wherein the layers are 20-260 nm in thickness.

2. The film of claim 1, wherein at least some of the layers comprise chitosan.

3. The film of claim 1, wherein at least some of the layers comprise alginate.

4. The film of claim 1 comprising void spaces.

5. The film of claim 4, wherein the void spaces have a largest dimension less than the thickness of the layer in which the void resides.

6. The film of claim 5, wherein the void spaces have a largest dimension less than 50 nm.

7. The film of claim 1 comprising a plurality of particles.

8. The film of claim 7, wherein the particles have a largest dimension less than the thickness of the layer in which the particle resides.

9. The film of claim 8, wherein the particles have a largest dimension less than 50 nm.

10. The film of claim 7, wherein the particles comprise transition metals.

11. The film of claim 7, wherein the particles comprise gold, platinum, silver, or any
combination thereof.

12. The film of claim 7, wherein the particles are substantially spherical.

13. The film of claim 7, wherein the particles comprise one or more wires, each having a diameter less than the thickness of the layer.

14. The film of claim 1, wherein the film comprises at least one layer with a refractive index of 1.70 to 1.30.

15. The film of claim 14, wherein the film comprises at least two layers and where at least two layers differ in refractive index by at least 0.05.

16. A sensor for heavy metal ions comprising a film of claim 1.

17. The sensor of claim 16, wherein the film is adhered to an external surface of a substrate.

18. The sensor of claim 16 comprising chitosan, covalently modified chitosan, or alginate.

19. A method of producing a biopolymer film comprising:
providing a plurality of layers, at least some of the layers comprising cross-linked chitosan or alginate, said layers comprising a plurality of dispersed particles, the particles having a largest dimension less than the thickness of the layer; and
removing said particles from the layer, producing void spaces within said layer.

20. The method of claim 19 comprising chitosan.

21. The method of claim 19 comprising alginate.

22. The method of claim 19, wherein said dispersed particles are removed by dissolving the particles in a solvent and separating the solvent from the film.

23. The method of claim 19, wherein the particles comprise latex.

24. The method of claim 23, wherein the latex is carboxylic acid modified latex.

25. A method of producing a composition comprising:
forming a multilayer film comprising a plurality of layers, at least some of the layers comprise cross-linked chitosan or alginate and particles or void spaces; wherein the layers are 20-260 nm in thickness,
converting the film to a series of pieces,
dissolving or dispersing the platelets into a liquid.

26. The method of claim 25, wherein the film comprises cross-linked chitosan.

27. The method of claim 26, wherein the film comprises cross-linked alginate.

28. The method of claim 26, wherein the film comprises void spaces.

29. The method of claim 28, wherein the void spaces are formed by providing a film comprising a plurality of layers having dispersed particles, the particles having a largest dimension less than the thickness of the layer; and removing said particles from the layer, producing void spaces within said layer.

30. The method of claim 28, wherein the particles are latex.

31. The method of claim 28, wherein the void spaces are formed either before or after the film is converted to platelets.

32. A multilayer film comprising at least two of:
a layer comprising a first polymer;
a layer comprising a second polymer;
a layer comprising particles, wherein said particles comprise ceramic material, metallic species, or both; and,
a layer comprising a combination of said first polymer and said particles;
wherein said multilayer film is capable of displaying structural color.

33. The multilayer film according to claim 32, wherein said first polymer is a biopolymer.

34. The multilayer film according to claim 33 wherein said first polymer is alginate, chitosan, chondroitin sulfate, hyaluronic acid, or any combination thereof.

35. The multilayer film according to claim 32 wherein said second polymer is poly(2,2,3,3,4,4,4-heptafluoromethacrylate-co-glycidyl methacrylate), poly(pentabromo-phenylmethacrylite-co-glycidyl-methacrylate), or polymerized titanium methacrylate triisopropoxide.

36. The multilayer film according to claim 32 comprising a layer comprising a first polymer and a layer comprising a second polymer, wherein said layer comprising a first polymer is adjacent to said layer comprising a second polymer without intervening layers, and wherein the refractive index of said second polymer is higher than the refractive index of said first polymer.

37. The multilayer film according to claim 32 wherein said metallic species comprises gold, silver, platinum, lead, palladium, lead acetate, zinc chloride, copper (II) sulfide pentahydrate, chromium (III) chloride, alumina, or any combination thereof.

38. The multilayer film according to claim 32 wherein said ceramic material comprises an oxide, a non-oxide, a composite, or any combination thererof.

39. The multilayer film according to claim 32 comprising a layer comprising a first polymer, a layer comprising a metallic species or a ceramic material, and a second layer comprising a first polymer, wherein said layer comprising a metallic species or a ceramic material or both is interposed between said layer comprising a first polymer and said second layer comprising a first polymer.

40. The multilayer film according to claim 32 comprising a layer comprising a first polymer, wherein said layer further comprises void spaces, and wherein said void spaces have a largest dimension less than the thickness of said layer.

41. The multilayer film according to claim 32 wherein said layers are about 20 nm to about 1.2 μm in thickness.
